(19) United States
(12) Patent Application Publication
(10) Pub. No.: US 2012/0236541 A1
(43) Pub. Date: Sep. 20, 2012

(54) FRAME ASSEMBLY AND DISPLAY

(75) Inventor: Cheng-Kung Chen, Taichung City (TW)

(73) Assignee: CHUNGHWA PICTURE TUBES, LTD., Taoyuan (TW)

(21) Appl. No.: 13/156,353

(22) Filed: Jun. 9, 2011

(30) Foreign Application Priority Data
Mar. 16, 2011 (TW) 100204682

(51) Int. Cl. G02F 1/13357; H04N 5/655

(52) U.S. Cl. 362/97.2; 312/223.1; 362/97.1

(57) ABSTRACT

A frame assembly including a back cover, a plastic frame, and a front frame and a display having the frame assembly are provided. The back cover has a first sidewall portion including a flat wall and a fastener connected with the flat wall. The fastener has a first contacting surface. The plastic frame has a second sidewall portion having a stopping structure to construct an opening in the second sidewall portion. The stopping structure has a second contacting surface facing the fastener and partially contacting with the first contacting surface. The front frame has a third sidewall portion having an aperture so that the fastener is located in the aperture. The aperture exposes a third contacting surface of the third sidewall portion. The third contacting surface partially contacts with the first contacting surface. The second sidewall portion is located between the first sidewall portion and the third sidewall portion.

### CROSS-REFERENCE TO RELATED APPLICATION

This application claims the priority benefit of Taiwan application serial no. 100204682, filed Mar. 16, 2011. The entirety of the above-mentioned patent application is hereby incorporated by reference herein and made a part of this specification.

### BACKGROUND OF THE INVENTION

1. Field of Invention

The invention generally relates to a frame assembly and a display, and more particularly, to a frame assembly having structurally simple design and a display using the frame assembly.

2. Description of Related Art

Recently, liquid crystal displays (LCDs), organic light emitting displays (OLEDs), or plasma display panel (PDP) displays have become main stream in the display market, and LCDs are particularly popular. The LCD panel does not emit light itself so a backlight module is arranged below the LCD panel to provide the surface light source for the LCD panel, to allow it to perform the display function and obtain the required brightness and contrast. Accordingly, for LCDs, the LCD panel is required to be assembled with a backlight module to facilitate the display function.

Generally, in order to provide the surface light source, the backlight module includes not only the light emitting element, but also a light guide plate and other elements. Therefore, the backlight module needs to be supported by a back cover. In addition, the relative position and distance between the backlight module and the LCD panel need be maintained, and thus a plastic frame is also required in the LCD to fix the backlight module and the LCD panel to the desired position. Even a front frame is required to sandwich the LCD panel and the backlight module in between the front frame and the back cover. The plastic frame and the back cover are configured to fix with each other through specific fastener structure, and similarly, the back cover and the front frame are required to fix with each other through another specific fastener structure. Accordingly, at least two fastener structures are configured on the back cover to respectively fix with the plastic frame and the front frame.

In the known design, the fasteners are formed on the back cover through a punching process. A breaking hole to prevent cracking during the punching process is formed corresponding to a side of the fastener so that undesirable cracks are avoided in the back cover. The more fasteners configured on the back cover, the more the corresponding breaking holes for preventing cracking. As such, dirt, contaminants, and the like can easily enter into the inner portion of the LCD from the breaking holes, contaminating the elements inside the LCD.

### SUMMARY OF THE INVENTION

The invention provides a frame assembly to reduce the possibility that the contaminants enter the inner portion of the frame assembly.

The invention provides a display module, in which the problem of the contaminants entering the display module owing to many breaking holes configured in the frame for assembling is prevented.

The invention is directed to a frame assembly for assembling a display module. The frame assembly includes a back cover, a plastic frame, and a front frame. The back cover has a first sidewall portion. The first sidewall portion includes a flat wall and a fastener, wherein the fastener is connected with the flat wall and protruded outward from the flat wall, the flat wall has a breaking hole corresponding to the fastener, and the fastener has a first contacting surface not coplanar with the flat wall. The plastic frame has a second sidewall portion. The second sidewall portion has a stopping structure to construct an opening in the second sidewall portion, wherein the fastener is located in the opening when the back cover and the plastic frame are assembled, and the stopping structure shields at least a portion of the breaking hole and has a second contacting surface facing to the fastener, such that the second contacting surface partially contacts with the first contacting surface. The front frame has a third sidewall portion having an aperture so that the fastener is located in the aperture. The aperture exposes a third contacting surface of the third sidewall portion such that the third contacting surface partially contacts with the first contacting surface. The second sidewall portion is located between the first sidewall portion and the third sidewall portion when the back cover, the plastic frame, and the front frame are assembled.

According to an embodiment of the invention, a protruding dimension defined by the fastener protruded outward from the flat wall is larger than or equivalent to a sum of a thickness of the second sidewall portion and a thickness of the third sidewall portion.

According to an embodiment of the invention, the number of the fasteners is one.

According to an embodiment of the invention, the opening of the second sidewall portion and the aperture of the third sidewall portion are at least partially overlapped and the fastener is located in both the opening and the aperture.

According to an embodiment of the invention, the display module includes a backlight module and a display panel. The backlight module is configured on the back cover, the display panel is configured on the plastic frame, and the plastic frame is partially located between the display panel and the backlight module. The display panel, the plastic frame, and the backlight module are sandwiched in between the front frame and the back cover. In one embodiment, the backlight module includes a light source, a light guide plate, and an optical film assembly. The light source and the optical film assembly are located at two different sides of the light guide plate, and the optical film assembly is located at a side of the light guide plate adjacent to the display panel. In addition, the display panel has an upper polarizer and a lower polarizer opposite to the upper polarizer, and the lower polarizer is located at a side of the display panel adjacent to the backlight module. In the present embodiment, the display panel may be a liquid crystal display (LCD) panel.

The invention further directs to a display including a back cover, a plastic frame, a front frame, and a display module. The back cover has a first sidewall portion. The first sidewall portion includes a flat wall and a fastener, wherein the fastener is connected with the flat wall and protruded outward from the flat wall, the flat wall has a breaking hole corresponding to the fastener, and the fastener has a first contacting surface not coplanar with the flat wall. The plastic frame has a second sidewall portion. The second sidewall portion has a stopping structure to construct an opening in the second sidewall portion, wherein the fastener is located in the opening when the back cover and the plastic frame are assembled, and the stopping structure shields at least a portion of the breaking hole and has a second contacting surface facing to the fastener, such that the second contacting surface partially contacts with the first contacting surface. The front frame has a third sidewall portion. The second sidewall portion is located between the first sidewall portion and the third sidewall portion when the back cover, the plastic frame, and the front frame are assembled. The third sidewall portion has an aperture such that the fastener is located in the aperture. The aperture exposes a third contacting surface of the third sidewall portion such that the third contacting surface partially contacts with the first contacting surface. The display module includes a backlight module and a display panel. The backlight module is configured on the back cover, the display panel is configured on the plastic frame, the plastic frame is partially located between the display panel and the backlight module, and the display panel, the plastic frame, and the backlight module are sandwiched in between the front frame and the back cover.

According to an embodiment of the invention, a protruding dimension defined by the fastener protruded outward from the flat wall of the first sidewall portion is larger than or equivalent to a sum of a thickness of the second sidewall portion and a thickness of the third sidewall portion.

According to an embodiment of the invention, the number of the fasteners is one.

According to an embodiment of the invention, the opening of the second sidewall portion and the aperture of the third sidewall portion are at least partially overlapped and the fastener is located in both the opening and the aperture.

In view of the above, one fastener is configured in the back cover for supporting the backlight module such that the plastic frame and the front frame are locked simultaneously with the back cover through the fastener according to the invention. Accordingly, the breaking hole corresponding to the fastener is merely one, which facilitates to reduce the possibility that contaminants enter the inner portion of the frame assembly or the display and improves the quality and the lifetime of the display.

In order to make the aforementioned and other features and advantages of the invention more comprehensible, several embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 schematically illustrates a back cover according to an embodiment of the invention.

FIG. 2 schematically illustrates a portion of a plastic frame and a portion of a back cover assembled together according to an embodiment of the invention.

FIG. 3 schematically illustrates a partial view showing a display module assembled by a back cover and a plastic frame according to an embodiment of the invention.

FIG. 4 and FIG. 5 schematically illustrate a front frame and a back cover assembled together according to an embodiment of the invention.

FIG. 6 schematically illustrates a partial view of a display according to an embodiment of the invention.

### DETAILED DESCRIPTION OF EMBODIMENTS

Specifically, one embodiment of the invention provides to a frame assembly consisting of a back cover, a plastic frame, and a front frame. The frame assembly is used for assembling a display module to form a display. The embodiments of the back cover, the plastic frame, the front frame, and the display are exemplarily described in the following, but the invention is not limited thereto.

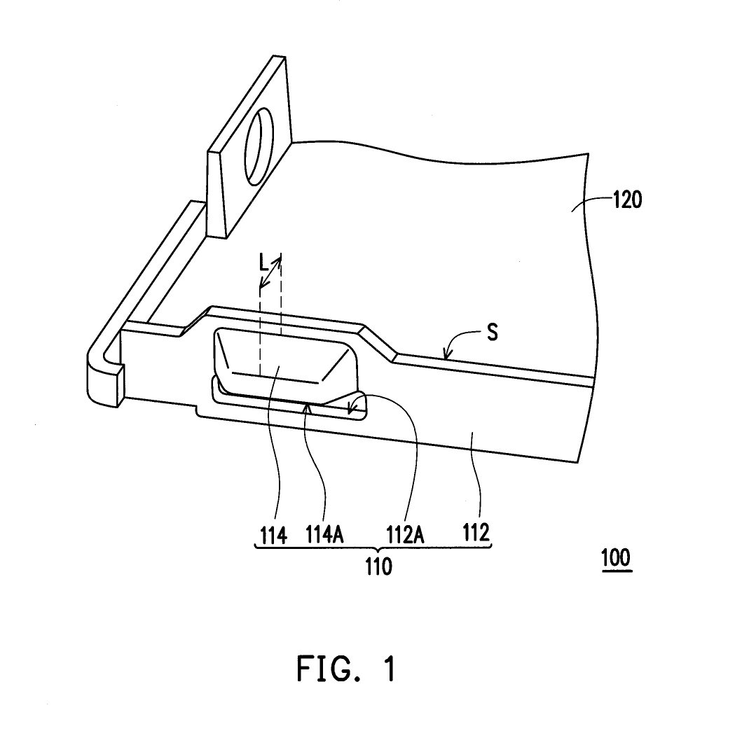

FIG. 1 schematically illustrates a back cover according to an embodiment of the invention. Referring to FIG. 1, the back cover 100 has a first sidewall portion 110 and a bottom portion 120 in the present embodiment, wherein the first sidewall portion 110 is, for example, connected to the edge of the bottom portion 120 and the first sidewall portion 110 can be perpendicular to the bottom portion 120. In detail, the first sidewall portion 110 and the bottom portion 120 define an accommodating space S.

In addition, the first sidewall portion 110 includes a flat wall 112 and a fastener 114, wherein the fastener 114 is connected with the flat wall 112 and protruded outward from the flat wall 112. The flat wall 112 has a breaking hole 112A corresponding to the fastener 114. In the present embodiment, the fastener 114 is protruded toward a direction away from the accommodating space S from the flat wall 112. The fastener 114 has a first contacting surface 114A not coplanar with the flat wall 112.

The back cover 100 is formed by a metal plate through a punching process, for example. For fabricating the protruding fastener 114, a portion of the fastener 114, such as the first contacting surface 114A, is required to be separated from the flat wall 112 so that the breaking hole 112A is formed. The configuration of the breaking hole 112A is conducive to preventing the mechanical strength of the back cover 100 from being reduced owing to undesirable cracks generated during the punching process. In the present embodiment, the back cover 100 has only one fastener 114, i.e. the number of the fasteners 114 is one. At the same time, the number of the breaking holes 112A is one, reducing the possibility that the mechanical strength of the back cover 100 is negatively influenced by the breaking hole 112A. In other words, because the number of the breaking holes 112A formed in the back cover 100 is less, the first side wall portion 110 can have desirable mechanical strength.

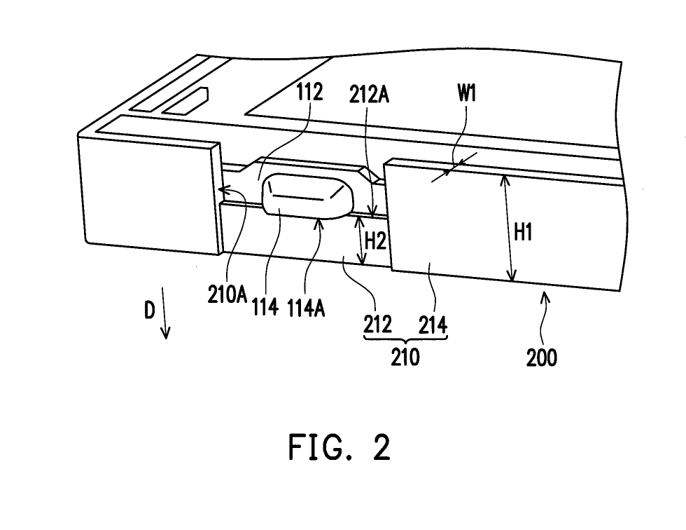

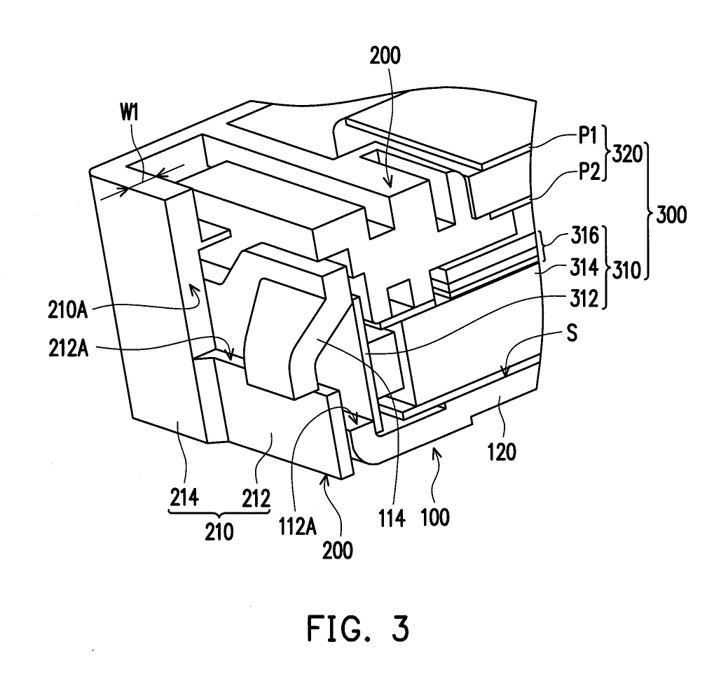

FIG. 2 schematically illustrates a portion of a plastic frame and a portion of a back cover assembled together according to an embodiment of the invention and FIG. 3 schematically illustrates a partial view showing a display module assembled by a back cover and a plastic frame according to an embodiment of the invention. Referring to FIG. 1, FIG. 2, and FIG. 3 simultaneously, the plastic frame 200 is, for example, assembled with the aforesaid back cover 100 in the present embodiment. The plastic frame 200 has a second sidewall portion 210. The second sidewall portion 210 has a stopping structure 212 to construct an opening 210A in the second sidewall portion 210. In addition, the fastener 114 is located in the opening 210A when the back cover 100 and the plastic frame 200 are assembled, and the stopping structure 212 shields at least a portion of the breaking hole 112A and has a second contacting surface 212A facing to the fastener 114, such that the second contacting surface 212A partially contacts with the first contacting surface 114A.

In detail, the second sidewall portion 210 of the plastic frame 200 further has a body portion 214 in addition to the stopping structure 212 according to the present embodiment. The body portion 214 is connected to the stopping structure 212 and a height H1 of the body portion 214 is larger than a height H2 of the stopping structure 212. Under this configuration, the body portion 214 and the stopping structure 212 surround an opening 210A. Herein, the opening 210A is, for example, a non-closed opening, i.e. the second sidewall portion 210 substantially forming three sides of a rectangle defines the opening 210A and the other side of the rectangle is not closed. In other words, the opening 210A is a ‘U” shaped opening. Nevertheless, the configuration of the “U” shaped opening is taken as an example and is not intended to limit the invention.

It is noted that a protruding dimension L that the fastener 114 configured on the first sidewall portion 110 of the back cover 100 protruded outward from the flat wall 112 is, for instance, larger than a thickness W1 of the second sidewall portion 210. Therefore, a portion of the fastener 114 is still protruded from the plastic frame 200 when the back cover 100 and the plastic frame 200 are assembled. Herein, the first contacting surface 114A and the second contacting surface 212A contact with each other so that the plastic frame 200 and the back cover 100 are fixed by the fastener 114 and the stopping structure 212. Through the fixing of the fastener 114 and the stopping structure 212, the plastic frame 200 and the back cover 100 are prevented from shifting or moving with respect to each other.

Furthermore, the stopping structure 212 in the present embodiment is relatively thin and the body portion 214 is relative thick so that the flexibility of the stopping structure 212 is better than that of the body portion 214. The stopping structure 212 can be easily moved from the top of the fastener 114 to the bottom of the fastener 114 along the assembling direction D so that the first contacting surface 114A and the second contacting surface 212A can contact with each other. That is to say, the characteristic of the thinner stopping structure 212 is conducive to enhance the convenience of the assembling.

Based on the drawing of FIG. 3, the back cover 100 and the plastic frame 200 can be used for assembling the display module 300. The display module 300 includes a backlight module 310 and a display panel 320. The backlight module 310 is configured on the back cover 100, and located in the accommodating space S of the back cover 100, for instance. The display panel 320 is configured on the plastic frame 200, and the plastic frame 200 is partially located between the display panel 320 and the backlight module 310.

The backlight module 310 can include a light source 312, a light guide plate 314, and an optical film assembly 316. The light source 312 and the optical film assembly 316 are located at two adjacent sides or two opposite sides of the light guide plate 314. In the present embodiment, the light source 312 and the optical film assembly 316 are located at two adjacent sides of the light guide plate 314, which is taken as an example and is not intended to limit the invention. The optical film assembly 316 is located at a side of the light guide plate 314 adjacent to the display panel 320. In addition, the display panel 320 can have an upper polarizer P1 and a lower polarizer P2 opposite to the upper polarizer P1, and the lower polarizer P2 is located at a side of the display panel 320 adjacent to the backlight module 310. In the present embodiment, the display panel 320 may be a liquid crystal display (LCD) panel.

Since the back cover 100 and the plastic frame 200 can be assembled through the fastener 114 and the stopping structure 212, the display panel 320 and the backlight module 310 can be fixed through the assembling of the back cover 100 and the plastic frame 200. Therefore, the display panel 320 and the backlight module 310 are not shifted or moved with respect to each other.

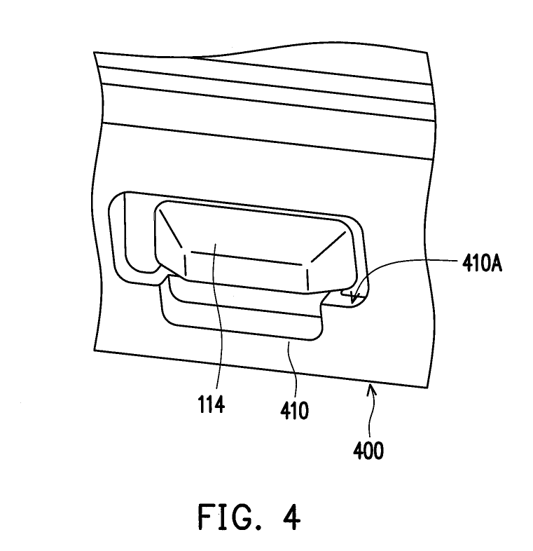

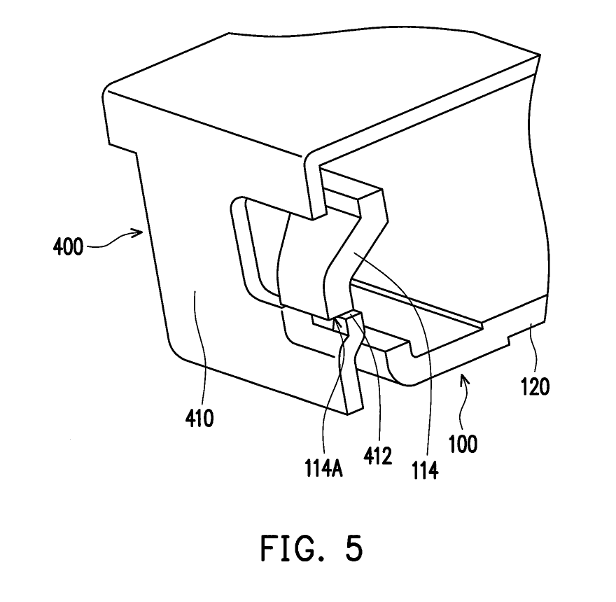

FIG. 4 and FIG. 5 schematically illustrate a front frame and a back cover assembled together according to an embodiment of the invention. Referring to FIG. 4 and FIG. 5, the back cover 100 has been depicted in the aforesaid embodiment and thus the reference number of certain components in FIG. 4 and FIG. 5 can be the same as the aforesaid embodiment. Specifically, the front frame 400 has a third sidewall portion 410. The third sidewall portion 410 has an aperture 410A so that the fastener 114 is located in the aperture 410A. In addition, the aperture 410A exposes a third contacting surface 412 of the third sidewall portion 410 such that the third contacting surface 412 partially contacts with the first contacting surface 114A.

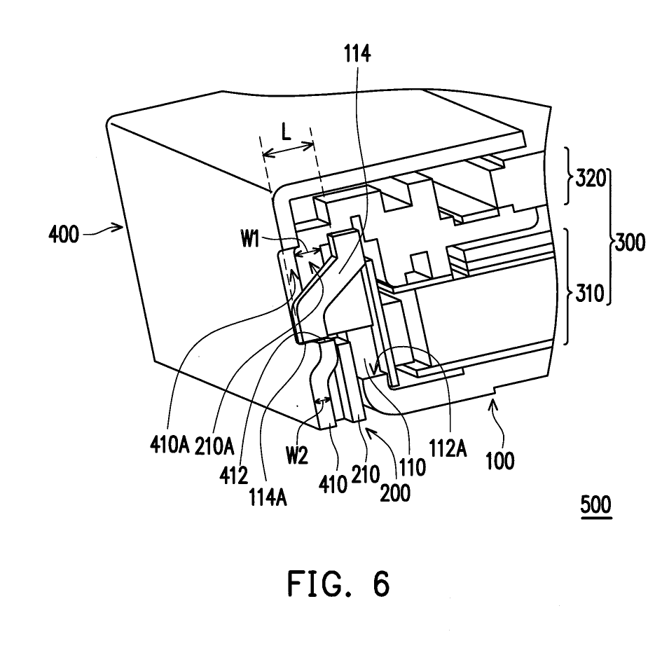

FIG. 6 schematically illustrates a partial view of a display according to an embodiment of the invention. Referring to FIG. 6, a display 500 includes the back cover 100, the plastic frame 200, the display module 300, and the front frame 400 which are depicted in the aforesaid embodiments. The display 500 is substantially formed by the front frame 400 assembled with the components depicted in FIG. 3. The second sidewall portion 210 is located between the first sidewall portion 110 and the third sidewall portion 410 when the back cover 100, the plastic frame 120, and the front frame 400 are assembled. Accordingly, the display panel 320, the plastic frame 200, and the backlight module 310 are sandwiched in between the front frame 400 and the back cover 100.

It is noted that a protruding dimension L of the fastener 114 configured on the back cover 100 of FIG. 1 protruded outward from the flat wall 112 is, for instance, larger than or equivalent to a sum of the thickness W1 of the second sidewall portion 210 and a thickness W2 of the third sidewall portion 410. In addition, the opening 210A of the second sidewall portion 210 as shown in FIG. 2 and the aperture 410A of the third sidewall portion 410 are at least partially overlapped and the fastener 114 is located in both the opening 210A and the aperture 410A. Accordingly, merely one fastener 114 is required to be configured on the back cover 100 to simultaneously assemble the plastic frame 200 and the front frame 400 with the back cover 100. A number of the breaking holes 112A corresponding to the fastener 114 is thus one. Therefore, dirt or contaminant which may cause negative influence on the quality or the lifetime of the display 500 is prevented from entering the inner portion of the display 500.

In brief, the protruding dimension of the fastener on the back cover is larger, and the opening configured in the plastic frame and the aperture configured in the front frame correspond to the fastener. Accordingly, merely one fastener facilitates to simultaneously assemble the back cover, the plastic frame and the front frame. The breaking hole corresponding to the fastener is merely one, which is conducive to improve the mechanical strength of the back cover and further prevent the dirt or contaminant from entering the inner portion of the display. Therefore, the frame assembly facilitates the display having desirable quality and prolonged life time.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A frame assembly for assembling a display module, comprising:
a back cover having a first sidewall portion, the first sidewall portion comprising a flat wall and a fastener, wherein the fastener is connected with the flat wall and protruded outward from the flat wall, the flat wall has a breaking hole corresponding to the fastener, and the fastener has a first contacting surface not coplanar with the flat wall;
a plastic frame having a second sidewall portion, the second sidewall portion has a stopping structure to construct an opening in the second sidewall portion, wherein the fastener is located in the opening when the back cover and the plastic frame are assembled, and the stopping structure shields at least a portion of the breaking hole and has a second contacting surface facing to the fastener, such that the second contacting surface partially contacts with the first contacting surface; and
a front frame having a third sidewall portion, the third sidewall portion having an aperture, and the fastener being located in the aperture, wherein the aperture exposes a third contacting surface of the third sidewall portion so that the third contacting surface partially contacts with the first contacting surface, and the second sidewall portion is located between the first sidewall portion and the third sidewall portion when the back cover, the plastic frame, and the front frame are assembled.

2. The frame assembly as claimed in claim 1, wherein a protruding dimension defined by the fastener protruded outward from the flat wall is larger than or equivalent to a sum of a thickness of the second sidewall portion and a thickness of the third sidewall portion.

3. The frame assembly as claimed in claim 1, wherein the opening of the second sidewall portion and the aperture of the third sidewall portion are at least partially overlapped and the fastener is located in both the opening and the aperture.

4. The frame assembly as claimed in claim 1, wherein the display module comprises a backlight module configured on the back cover and a display panel configured on the plastic frame, the plastic frame is partially located between the display panel and the backlight module, and the display panel, the plastic frame, and the backlight module are sandwiched in between the front frame and the back cover.

5. The frame assembly as claimed in claim 4, wherein the backlight module comprises a light source, a light guide plate, and an optical film assembly, the light source and the optical film assembly are located at two different sides of the light guide plate, and the optical film assembly is located at a side of the light guide plate adjacent to the display panel.

6. The frame assembly as claimed in claim 4, wherein the display panel has an upper polarizer and a lower polarizer opposite to the upper polarizer, and the lower polarizer is located at a side of the display panel adjacent to the backlight module.

7. The frame assembly as claimed in claim 6, wherein the display panel is a liquid crystal display panel.

8. A display, comprising:
a back cover having a first sidewall portion, the first sidewall portion comprising a flat wall and a fastener, wherein the fastener is connected with the flat wall and protruded outward from the flat wall, the flat wall has a breaking hole corresponding to the fastener, and the fastener has a first contacting surface not coplanar with the flat wall;
a plastic frame having a second sidewall portion, the second sidewall portion has a stopping structure to construct an opening in the second sidewall portion, wherein the fastener is located in the opening when the back cover and the plastic frame are assembled, the stopping structure shields at least a portion of the breaking hole and has a second contacting surface facing to the fastener, such that the second contacting surface partially contacts with the first contacting surface;
a front frame having a third sidewall portion, the third sidewall portion having an aperture, and the fastener being located in the aperture, wherein the aperture exposes a third contacting surface of the third sidewall portion so that the third contacting surface partially contacts with the first contacting surface, and the second sidewall portion is located between the first sidewall portion and the third sidewall portion when the back cover, the plastic frame, and the front frame are assembled; and
a display module comprising a backlight module configured on the back cover and a display panel configured on the plastic frame, wherein the plastic frame is partially located between the display panel and the backlight module, and the display panel, the plastic frame, and the backlight module are sandwiched in between the front frame and the back cover.

9. The display as claimed in claim 8, wherein a protruding dimension defined by the fastener protruded outward from the flat wall is larger than or equivalent to a sum of a thickness of the second sidewall portion and a thickness of the third sidewall portion.

10. The display as claimed in claim 8, wherein the opening of the second sidewall portion and the aperture of the third sidewall portion are at least partially overlapped and the fastener is located in both the opening and the aperture.
